(19) United States
(12) Patent Application Publication
(10) Pub. No.: US 2025/0096570 A1
(43) Pub. Date: Mar. 20, 2025

(54) TRANSMISSION LOSS MINIMIZATION MANAGEMENT SYSTEM

(71) Applicant: Standard Energy Inc., Daejeon (KR)

(72) Inventors: Dong Young Lee, Seoul (KR); Bu Gi Kim, Sejong (KR)

(21) Appl. No.: 18/843,221

(22) PCT Filed: Jun. 13, 2023
(86) PCT No.: PCT/KR2023/008081

§ 371 Date: Aug. 30, 2024

(30) Foreign Application Priority Data
Jun. 13, 2022 (KR) 10-2022-0071712

(51) Int. Cl. H02J 3/32; H02J 3/00; H02J 7/00

(52) U.S. Cl. CPC H02J 3/32; H02J 3/003; H02J 7/0048; H02J 2203/10; H02J 2203/20

(57) ABSTRACT

The present invention relates to a transmission loss minimization management system and, more specifically, to a transmission loss minimization management system implemented to minimize transmission loss by using an ESS in the transmission process of transmitting power from a power plant or substation to a substation or consumer, and to receive compensation corresponding to transmission loss minimization costs. The system of the present invention enables economical management by means of stable power transmission and thus can charge transmission and relay costs, and has energy environment improving effects such as energy conservation and carbon neutrality.

### TECHNICAL FIELD

The present disclosure relates to a transmission loss minimization management system, and more particularly to a transmission loss minimization management system implemented to minimize transmission losses using an ESS during transmission of power from a power plant or a substation to a substation or a consumer and to receive compensation corresponding to the cost of minimizing transmission losses.

### BACKGROUND ART

Unless otherwise indicated in this specification, the contents described in this section are not the prior art to the claims of this application, and inclusion in this section does not constitute the prior art.

During the transmission of power from a power plant to an ESS or a consumer via a transmission station, a substation, etc., power is inevitably lost. When transmission losses are incurred during the transmission process, the cost of power losses tends to be aggregated and managed in electricity bills.

In a system where electricity is transmitted from a power plant and billed according to usage, electricity prices are constantly rising due to increased usage, and as usage increases, transmission losses also increase, causing inefficiencies and increased costs for the overall power grid.

The transmission power is supplied by regulating the amount of current according to the demand of the consumer, and since the transmission loss is proportional to I²R, an instantaneous increase in power consumption causes a sharp increase in transmission losses.

Therefore, it is very important to minimize such transmission losses, but appropriate solutions have not yet been realized.

In order to solve this problem, the prior art, Korean Patent Registration No. 10-1758307, which is a prior art document, proposes an energy storage system operation method that enables efficient power trading of renewable energy sources stored in an energy storage system, such as wind power and solar power, to maximize profits from power trading, and Korean Patent Registration No. 10-2194123 proposes a power storage device including a power conversion unit that charges some of system power supplied to a receiver or supplies the charged power to the receiver in order to perform peak management, power arbitrage, and demand response functions in an organized manner and a controller that controls the charging and discharging operation of the power conversion unit according to a set charging and discharging schedule and controls the charging and discharging operation of the power conversion unit according to a set demand response schedule when a demand response curtailment instruction is received.

However, the conventional energy storage systems are simply used as a means of storing power and energy intermediation for power arbitrage according to energy demand, whereby a method of minimizing power losses is not considered.

### PRIOR ART DOCUMENTS

### Patent Documents

(Patent Document 1) Korean Patent Registration No. 10-1758307
(Patent Document 1) Korean Patent Registration No. 10-2194123

### DISCLOSURE

### Technical Task

The present disclosure aims to solve the above problems and to seek measures to reduce transmission losses and minimize transmission losses in transmitting energy from energy generating sources such as power plants and renewable energy sources to various consumers, rather than simple power trading through energy storage.

Therefore, it is an object of the present disclosure to provide a management system that enables minimization of transmission losses of power and compensation therefor.

It is another object of the present disclosure to provide a method of minimizing transmission losses in a process of transmitting power and for calculating the cost of minimizing transmission losses and charging the cost to a supplier.

The objects of the present disclosure are not limited to the above objects, but are to be understood to include all objects that can be inferred from the detailed description of the present disclosure or the configuration of the present disclosure described in the claims or all objects that can be achieved by the description or technical idea of the present disclosure.

### Technical Solutions

In order to accomplish the above objects, the present disclosure provides a transmission loss minimization management system wherein an energy storage system (ESS) for storing power is installed between a power plant and a substation or between a power plant or a substation and a consumer as an auxiliary means of power supply, in a transmission process from the power plant to the substation or from the substation to another substation or the consumer, the supply of power from the ESS is supplemented according to the power demand forecast result or the distance to the consumer, and the system includes one or more of assisting the transmission from the ESS when the power demand is equal to or greater than a standard value and supplementing some of the power stored in the ESS in the vicinity of the substation or the consumer.

In a preferred embodiment of the present disclosure, the system may include one or more of supplementing daytime output in consideration of characteristics of high daytime demand for power and reduced nighttime demand for power and supplementing some of the power at the ESS installed in the vicinity of the substation or the consumer by estimating the distance at which power losses are minimized.

In a preferred embodiment of the present disclosure, the system may include recording a demand curve for power, supplementing the power supply from the ESS by excess demand power when the power demand exceeds a certain level, receiving power from the power plant or the substation and charging the ESS if the power demand is equal to or less than the certain level, estimating a loss minimization cost of the transmission power calculated by dividing a power consumption time period of the consumer into certain sections and calculating a transmission loss minimization cost by Mathematical Equation 1 below, and receiving compensation by charging all or some of a value corresponding to the difference generated by the loss minimization cost to a power supplier.

$$Transmission minimization cost = {\sum }_{time} \{ ( estimated amount of transmission losses based on existing demand ) - ( actual amount of transission losses ) \} \times ( power cost by time of day ) \qquad [ Mathematical Equation 1 ]$$

In a preferred embodiment of the present disclosure, the optimal location of the ESS may be selected in consideration of the location of the power plant, the location of the substation, or the location of the consumer based on the distance between and distribution of the locations, and the location where power loss costs can be minimized to a maximum extent may be selected based on the estimate result of the transmission loss costs by simulation such that the ESS is installed at the location.

In a preferred embodiment of the present disclosure, the ESS may include a database unit comprising one or more pieces of real-time accumulated information, among specifications, use, and management state of the ESS for at least one ESS,
a state information collection unit configured to collect and update information related to a state of charge (SoC) of the ESS in real time,
a usage state recognition unit comprising situational information checked during use of the ESS,
an algorithm generating unit configured to apply reinforcement learning to the information from one or more of the database unit, the state information collection unit, and the usage state recognition unit, and
a central controller having a charging and discharging algorithm including an execution command unit configured to determine whether or not to use the ESS, including application of a compensation function to the algorithm, applied thereto.

In a preferred embodiment of the present disclosure, an algorithm for applying the reinforcement learning may include the design of the compensation function.

In a preferred embodiment of the present disclosure, the algorithm for applying the reinforcement learning may include continuous API queries and storage of fluctuating values.

In a preferred embodiment of the present disclosure, the ESS may include information in which the start time and the end time of battery charging are undated.

In a preferred embodiment of the present disclosure, the charging and discharging algorithm may include reinforcement learning having an objective function of electric bill minimization.

In a preferred embodiment of the present disclosure, the ESS may include demand forecast data.

In a preferred embodiment of the present disclosure, the ESS may utilize information for acquiring location information for newly created or decommissioned power plants, substations, and consumers.

In a preferred embodiment of the present disclosure, at least a part of the ESS may include vanadium-based battery cells. The entire battery may be constituted by vanadium-based battery cells.

In addition, the present disclosure provides an ESS installation system for transmission loss minimization wherein an energy storage system (ESS) for storing power is installed between a power plant and a substation or between a power plant or a substation and a consumer as an auxiliary means of power supply, and
the ESS includes a database unit including one or more pieces of real-time accumulated information, among specifications, use, and management state of the ESS for at least one ESS,
a state information collection unit configured to collect and update information related to the state of charge (SoC) of the ESS in real time,
a usage state recognition unit including situational information checked during use of the ESS, and
a central controller configured to regulate charging and discharging of the ESS when the transmission power capacity of the power plant and the substation and the power demand of the consumer are equal to or greater than a standard value.

In a preferred embodiment of the present disclosure, at least one ESS, power plant, or substation may transmit an identification signal in order to identify the supply entity when the ESS supplies power or is charged. The identification signal may be transmitted by transmitting a high frequency signal through the power line, or through transmission using separate communication line, or through transmission using wireless communication.

In a preferred embodiment of the present disclosure, at least one ESS, power plant, or substation may transmit an identification signal in order to identify the supply entity when the ESS supplies power or is charged, wherein a process of transmitting and receiving the amount of power transmitted, the estimated amount of losses, or the estimated amount of power received using a predetermined communication method in addition to the identification signal to match the actual amount of power moved between the supplier and the receiver may be included. The accuracy of the identification of the supply entity may be increased through matching of the amount of power moved, whereby security may be improved.

In a preferred embodiment of the present disclosure, an energy storage system (ESS) for storing power may be installed between a power plant and a substation or between a power plant or a substation and a consumer as an auxiliary means of power supply, wherein the ESS may installed at a predetermined location according to the power demand forecast result or the distance to the consumer in a transmission process from the power plant to the substation or from the substation to another substation or the consumer.

In a preferred embodiment of the present disclosure, the ESS may assist the supply of power according to the power demand forecast result or the distance to the consumer in a transmission process from the power plant to the substation or from the substation to another substation or the consumer.

In addition, the present disclosure provides a transmission relay cost charging method through transmission loss minimization management, the transmission relay cost charging method including recording a demand curve of power transmitted from a power plant or a substation to a consumer, a transmission assistance step of transmitting pre-stored power from at least one energy storage system (ESS) installed between the power plant and the substation or between the power plant or the substation and the consumer as an auxiliary means of power supply when a power demand exceeds a certain level, charging the ESS when the power demand is equal to or less than the certain level, estimating a loss minimization cost of the transmission power calculated by dividing a daily time period into certain sections and calculating a transmission minimization cost by Mathematical Equation 1 above; and receiving compensation by charging all or some of a value equivalent to the amount to a power supplier.

In a preferred embodiment of the present disclosure, one or more ESSs may be installed according to the location of the power plant, the location of the substation, and the distribution of consumers, whereby the transmission loss minimization cost may be charged.

In addition, the present disclosure provides a transmission loss minimization management system including supplementing daytime output in consideration of characteristics of high daytime demand for power and reduced nighttime demand for power and supplementing some of the power, wherein supplementary supply is performed utilizing an ESS installed in the vicinity of a power plant, a substation, or a consumer, to which power is supplied, the ESS including a vanadium-based battery cell.

In addition, the present disclosure provides a transmission loss minimization management system including recording a demand curve of power; supplementing the supply of power using an energy storage system (ESS) including a vanadium-based battery cell when a demand exceeds a certain level, charging the ESS when the demand is equal to or less than the certain level, estimating a loss minimization cost of transmission power calculated by dividing a daily time period into certain sections and calculating a transmission minimization cost according to Mathematical Equation 1 above, and receiving compensation by charging all or some of the amount to a power supplier.

### Advantageous Effects

The present disclosure is configured to utilize an ESS installed at an optimized location in consideration of power consumption and distance during transmission from a power plant or a substation to a consumer, whereby transmission losses may be minimized by adjusting the unnecessary or excessive transmission state or the transmission state during times of excessive power consumption, and therefore an energy saving system capable of suppressing power waste may be realized.

In addition, since the transmission loss minimization management system of the present disclosure may reduce energy lost during transmission, the system may contribute to efficient energy use and carbon neutrality, and may be used as an environmentally friendly measure.

In addition, the present disclosure can reduce disadvantages to consumers by realizing transmission loss minimization, calculating the cost of transmission loss minimization, and charging this value to a power supplier for compensation. In addition, it is possible to improve the service of consumers for energy supply and to rationalize the power bill such that there is no unreasonable economic damage to consumers in an ESS management process.

In particular, when vanadium-based battery (VIB) cells are applied to the ESS in the transmission loss minimization management system of the present disclosure, there is no concern about fire, and therefore it is possible to install the ESS at locations adjacent to various major industrial facilities, densely populated areas, large residential areas, etc., whereby it possible to supply power to consumers in safe, stable, and highly economical conditions.

The effects of the present disclosure are not limited to the above effects, but are to be understood to include all effects that can be inferred from the detailed description of the present disclosure or from the configuration of the present disclosure described in the claims.

### DESCRIPTION OF DRAWINGS

FIG. 1 is an illustrative view showing a graph of real-time power supply and demand by time period in a conventional transmission process.

FIG. 2 is a conceptual view of an example of an ESS utilization scheme applied to a transmission loss minimization management system of the present disclosure, illustratively showing a system application relationship for a transmission loss minimization means.

### BEST MODE FOR DISCLOSURE

Hereinafter, the present disclosure will be described in more detail as an implementation.

For reference, in the drawings attached to the present disclosure, each component shown in the drawings is omitted or schematically illustrated for convenience and clarity in the description of the present disclosure, and the size of each component and components are not necessarily reflective of actual size or overall actual design form. In addition, throughout the specification, representations of components in the description of the components may refer to the same components as in the drawings, and reference numerals for identical components or components that may be readily recognized in the individual figures may be omitted.

The present disclosure relates to a transmission loss minimization management system implemented to minimize transmission losses during the transmission of power from a power plant, to which an energy source is supplied, to a substation or a consumer and to receive compensation for the cost of minimizing transmission losses.

According to a preferred embodiment of the present disclosure, the energy source supplied to the power plant includes, for example, energy generated by various conventional power generation facilities, renewable energy, and environmental energy. Thus, the energy source may include not only energy generated by hydroelectric, nuclear, and thermal power, but also energy generated by renewable energy, including solar and wind power, where the supply of energy is not constant.

In the present disclosure, therefore, the power plant includes a place that produces these various energy sources. Also, in the present disclosure, the substation refers to a place where power, which is energy produced by the power plant, is concentrated or distributed in different directions by appropriately converting the magnitude of the voltage to efficiently supply the power to electricity users.

The present disclosure provides a management system that minimizes transmission losses in order to solve the problem that the transmission losses increase due to an increase in the amount of power supplied from a power plant to a consumer and an increase in the amount of transmission caused by an increase in demand.

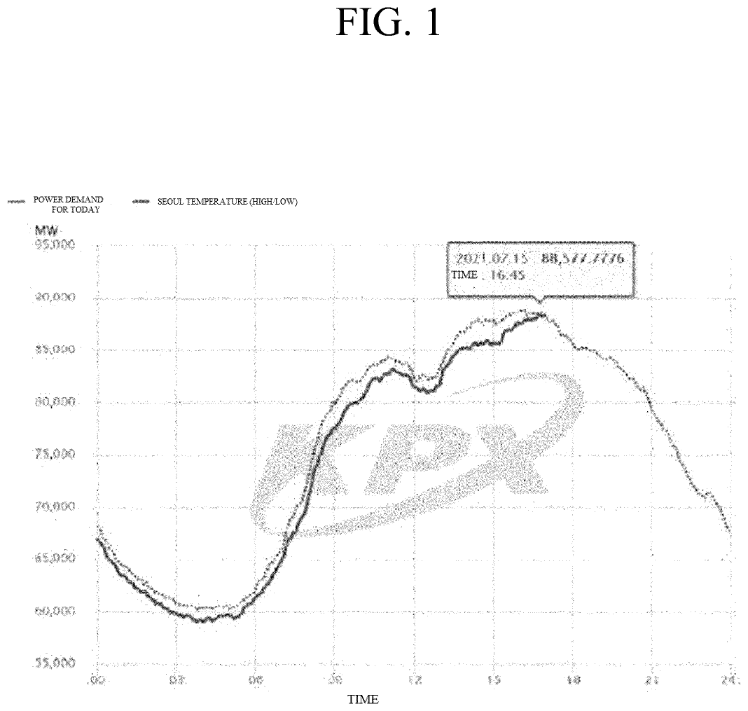

In general, transmission power is supplied by adjusting the amount of power supply according to the demand of the consumer, and since the transmission loss is proportional to the I²R, an instantaneous increase in the amount of power consumed causes a sharp increase in transmission losses. Therefore, as illustrated in FIG. 1, which is a real-time power recovery graph calculated as part of the power consumption prediction, for example, due to the characteristics of high power demand during the day and low power demand at night, it is possible to reduce transmission losses from the power plant by suppressing overcurrent and unnecessary current flow by designing the system to provide additional power supply with auxiliary power to supplement the excessive output during the day.

In addition, as another example of transmission losses, transmission losses are an important problem to be solved when power is transmitted over long distances under conditions of excessive or insufficient supply or demand for power, and in this case, transmission losses may also be reduced by a means capable of providing appropriate auxiliary power.

Therefore, the present disclosure presents a novel solution in that it is possible to provide a transmission loss minimization means configured to reduce the loss of transmission power supplied from a power plant based on the above reasons.

According to a preferred embodiment of the present disclosure, the transmission loss minimization means may include one or more of supplementing daytime output, most typically due to the high demand for power during the day and the reduced demand for power at night, and supplementing a part of the power in the vicinity of a substation or a consumer.

According to a preferred embodiment of the present disclosure, the minimized losses obtained by the transmission loss minimization means may be converted into a cost and charged to a power supplier.

According to a preferred embodiment of the present disclosure, the transmission loss minimization means may minimize transmission losses by, for example, supplementing a part of the power in the vicinity of a substation or a consumer.

According to a preferred embodiment of the present disclosure, a system for minimizing transmission losses by supplementing a part of the power at a substation or near a consumer, converting power saved through minimization of transmission losses into a cost, and charging the same to a supplier may be included.

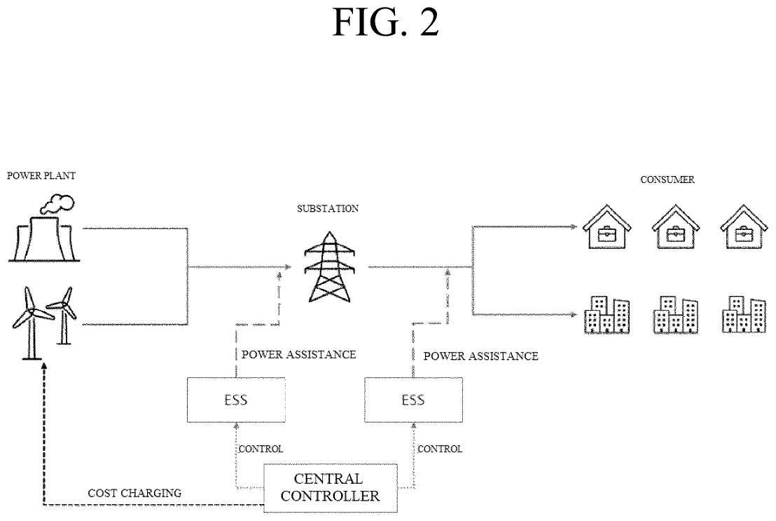

The relationship to the transmission loss minimization means is illustrated in FIG. 2 as an example of a linkage process.

According to an embodiment of the present disclosure, a scheme capable of efficiently operating the transmission loss minimization means is illustrated as follows.

According to a preferred embodiment of the present disclosure, an energy storage system (ESS) for storing power may be installed between a power plant and a substation, or between a power plant or a substation and a consumer as an auxiliary means of power supply. In this way, in the transmission process from a power plant to a substation or from a substation to another substation or a consumer, the supply of power from the ESS may be supplemented according to the power demand forecast results or the distance to a consumer. Therefore, a system capable of minimizing transmission losses may be configured by including one or more of the following measures: assisting the transmission from the ESS when the power demand is equal to or greater than a standard value and assisting some of the power stored in the ESS in the vicinity of a substation or a consumer.

According to a preferred embodiment of the present disclosure, the system may typically include one or more of, for example, supplementing daytime output in consideration of the characteristics of high daytime demand for power and reduced nighttime demand for power and supplementing some of the power at an ESS installed in the vicinity of a substation or a consumer by predicting the distance at which transmission losses are minimized.

According to a preferred embodiment of the present disclosure, the present disclosure may minimize transmission losses through certain processes in the system.

For example, a step of recording a demand curve for power may be performed. In this step, when the predicted power demand exceeds a certain level, a step of supplementing the power supply from the ESS by the excess demand power may be performed. If the power demand is equal to or less than the certain level, a step of receiving power from a power plant or a substation and charging the ESS may be performed.

According to a preferred embodiment of the present disclosure, a step of estimating a loss minimization cost of the transmission power calculated by dividing the power consumption time period of the consumer into certain sections and calculating the transmission minimization cost by Mathematical Equation 1, and a step of receiving compensation by charging all or some of the value corresponding to the difference generated by the loss minimization cost to a power supplier may be included. Here, the value corresponding to the difference may include one or more of tangible and intangible things having a property value, such as cash or an equivalent amount of power.

$$Transmission minimization cost = {\sum }_{time} \{ ( estimated amount of transmission losses based on existing demand ) - ( actual amount of transission losses ) \} \times ( power cost by time of day ) \qquad [ Mathematical Equation 1 ]$$

As described above, the installation of the ESS, which is importantly applied in the transmission loss minimization management system of the present disclosure, is important.

According to a preferred embodiment of the present disclosure, the optimal location of the ESS is preferably selected in consideration of the location of the power plant, the location of the substation, or the location of the consumer based on the distance between and distribution of the locations. Such location selection may be determined based on the state in which the transmission losses can be minimized by simulation considering the supply and demand forecast of power, the transmission loss rate according to the distance, and the transmission loss rate in excess or shortage compared to the average supply of power and the estimate results from which the transmission loss costs can be minimized, and installing the ESS in a location where the power loss costs can be minimized to the maximum extent may be included.

According to a preferred embodiment of the present disclosure, at least one ESS may be installed between pluralities of power plants, substations, and consumers, and the ESS may be efficiently managed, for example, by a central controller to regulate the timing of charging and discharging, the amount of charging and discharging, and the like.

According to a preferred embodiment of the present disclosure, the state of at least one ESS may be managed through, for example, a database unit including one or more pieces of real-time accumulated information, among the specifications, use, and management state of the ESS, and a state information collection unit configured to collect and update information related to the state of charge (SoC) of the ESS in real time.

According to a preferred embodiment of the present disclosure, the ESS for which data and information are collected as described above may include a usage state recognition unit including situational information checked during use of the ESS.

In addition, according to a preferred embodiment of the present disclosure, an algorithm generating unit configured to apply, for example, reinforcement learning to the information from one or more of the database unit, the state information collection unit, and the usage state recognition unit. The algorithm generating unit may be applied to manage the ESS in real time, for example, in order to more efficiently minimize transmission losses in real time.

Thus, according to a preferred embodiment of the present disclosure, it is possible to more effectively apply a charge/discharge algorithm including an execution command unit configured to determine whether or not to use the ESS including application of a compensation function to the algorithm.

According to a preferred embodiment of the present disclosure, the central controller of the ESS including the above means may be included to efficiently minimize transmission losses.

According to a preferred embodiment of the present disclosure, the algorithm may more accurately check the state of the ESS, including, for example, the design of the compensation function, and regulate the charging and discharging state and execution.

According to a preferred embodiment of the present disclosure, the algorithm may be effectively applied to the management of the ESS through continuous API queries and storage of fluctuating values.

According to a preferred embodiment of the present disclosure, information in which the start time and end time of the battery charging are updated for the ESS may be included.

According to a preferred embodiment of the present disclosure, the charging and discharging algorithm may include reinforcement learning, for example, with an objective function of electric bill minimization.

According to a preferred embodiment of the present disclosure, the ESS may further include demand forecast data to enable the power demand to be predicted through the charging and discharging process.

According to a preferred embodiment of the present disclosure, the ESS may include utilizing information from the surrounding environment to acquire location information about new and decommissioned power plants, substations, and consumers at various nearby locations. This may enable efficient management of the ESS.

According to a preferred embodiment of the present disclosure, safe management of the ESS, such as fire risk, is important to enable reliable management in utilizing the ESS.

According to a preferred embodiment of the present disclosure, at least a part of the battery may include vanadium-based battery cells, preferably vanadium ion battery (VIB) cells. Preferably, the entire battery is constituted by vanadium-based battery cells. Unlike conventional LIBs, the vanadium-based battery cells use an aqueous electrolytic solution as an electrolyte, and therefore there is no fire hazard. Therefore, there is an advantage of being installed and operated stably in areas requiring the highest safety management, such as major management facilities, large-scale data banks, government facilities, military facilities, communication facilities, hospitals, densely populated areas, and residential areas.

Therefore, according to a preferred embodiment of the present disclosure, when installing an ESS between a power plant, a substation, and a consumer, the ESS may be installed in an optimized place such that safety can be maintained regardless of the place, location, surrounding facilities, etc., whereby design for transmission loss optimization in the most appropriate way is possible.

Meanwhile, the present disclosure includes an ESS installation system for transmission loss minimization, wherein at least one ESS for power storage being installed between a power plant and a substation or between a power plant or a substation and a consumer as an auxiliary means of power supply,
the ESS includes a database unit including one or more pieces of real-time accumulated information, among specifications, usage, and management state of the ESS for the at least one ESS,
a state information collection unit configured to collect and update information related to the state of charge (SoC) of the ESS in real time,
a usage state recognition unit including situational information checked during use of the ESS, and
a central controller configured to regulate charging and discharging of the ESS when the transmission power capacity of the power plant and the substation and the power demand of the consumer are equal to or greater than a standard value.

According to a preferred embodiment of the present disclosure, the ESS may be installed at a predetermined location between a power plant and a substation or between a power plant or substation and a consumer according to the results of the power demand forecast or the distance to the consumer as an auxiliary means of power supply. Therefore, the ESS may assist the supply of power in the transmission process from a power plant to a substation or from a substation to another substation or a consumer according to the power demand forecast result or the distance to the consumer.

In addition, the present disclosure includes a transmission cost charging method through transmission loss minimization management, the transmission cost charging method including a step of recording a demand curve of power transmitted from a power plant or a substation to a consumer, a transmission assistance step of transmitting pre-stored power from at least one energy storage system (ESS) installed between a power plant and a substation or between a power plant or a substation and a consumer as an auxiliary means of power supply when the power demand exceeds a certain level, a step of charging the ESS when the power demand is equal to or less than the certain level, and a step of estimating a loss minimization cost of the transmission power calculated by dividing a daily time period into certain sections and calculating the transmission minimization cost by Mathematical Equation 1 above, and receiving compensation by charging all or some of the value of the amount to a supplier.

According to the transmission method of the present disclosure, at least one ESS may be installed depending on the location of the power plant, the location of the substation, and the distribution of consumers to charge a value corresponding to the cost of minimizing transmission losses.

According to a preferred embodiment of the present disclosure, in order to charge the transmission loss minimization cost, a bill may be generated and transmitted to the supplier, for example by calculating the minimization cost. For example, since the ESS compensates for transmission losses, the battery management system (BMS), the power conversion system (PCS), the energy management system (EMS), etc. constituting the ESS may calculate the transmission loss minimization cost as described above, automatically generate a bill in a preset form, and transmit the generated bill to the power supplier over a communication network.

In addition, according to a preferred embodiment of the present disclosure, power A output from the ESS to compensate for transmission losses during the daytime may be utilized as a method of receiving surplus power equivalent to A from the power supplier (the power plant) at night as compensation instead of calculating and charging the cost, and the cost may be charged to the consumer.

As described above, according to a preferred embodiment of the present disclosure, when the system and method for increasing transmission efficiency are applied, the consumer may smoothly receive power according to demand and only pay the usage cost according to the usage factor. However, the system and method may be configured to compensate for the transmission losses of the supplier and charge the supplier for the compensated losses. In addition, the risk reduction cost of increasing supply reliability by utilizing the ESS may also be charged.

Thus, according to a preferred embodiment of the present disclosure, in order to charge the transmission power loss minimization cost, all or some of the value of the amount may be charged to the supplier, for example, through a step of recording a demand curve, a step of supplementing the supply with the ESS when the demand exceeds a certain level, a step of charging the ESS when the demand is equal to or less than the certain level, and a step of estimating the loss minimization cost of transmission power calculated by dividing a daily time period into certain sections and calculating the transmission minimization cost according to Mathematical Equation 1 above.

Thus, according to a preferred embodiment of the present disclosure, as another example for minimizing lost power using the above method, the ESS may need to be close to a consumer, and in some cases, an intermediate ESS configured to assist the ESS in charging may be provided. According to the present disclosure, therefore, the optimal location of the ESS may be selected according to the location of the power plant, the location of the substation, and the distribution of the consumers in the city plan.

According to a preferred embodiment of the present disclosure, an artificial intelligence learning method such as reinforcement learning and machine learning may be employed to preferably locate the ESS. In this way, the artificial intelligence learning method may also be used to generate a SoC control strategy for each ESS based on the location, capacity, and expected demand of the ESS. According to the present disclosure, the charging and discharging algorithm, such as reinforcement learning, may further include one or more data of information related to location and capacity of the ESS, expected demand, transmission losses, and transmission loss minimization costs.

According to a preferred embodiment of the present disclosure, the transmission loss minimization management system of the present disclosure may be utilized by applying a battery management system based on the charge/discharge algorithm to the ESS.

According to the present disclosure, the charge and discharge algorithm may derive highly reliable results through application of AI. According to a preferred embodiment of the present disclosure, it is possible to minimize transmission losses and minimize power consumption, for example, by providing an ESS charging and discharging algorithm using reinforcement learning.

As used in the present disclosure, “reinforcement learning”, which is a kind of machine learning, means learning a behavior that maximizes a reward based on behavior and rewards in a specific environment. Basically, the reinforcement learning may be represented as a Markov decision process.

Typically, if the charge amount of the ESS is less than a first setting value set through the emergency storage of the ESS, a charging mode is set, and if the charge amount of the ESS is greater than the first setting value, a discharging mode is set. However, in this case, there is no consideration of time. That is, conventionally, reinforcement learning (artificial neural network) may be performed for the disposition of slow and fast chargers instead of SoC. Therefore, if the SoC of the ESS is equal to or greater than or equal to or less than a setting value, charging is unconditionally is performed, and the only condition that controls this is stability of a grid network, whereby charging is performed even when charging is unnecessary for efficiency, resulting in a waste of power.

According to a preferred embodiment of the present disclosure, the above problems may be solved through the reinforcement learning proposed by the present disclosure.

According to a preferred embodiment of the present disclosure, public or private data managing the ESS may be utilized as environmental data for reinforcement learning.

According to a preferred embodiment of the present disclosure, a virtual charging and discharging environment may be predicted and created by collecting, for example, power consumption forecasts and existing charging situation examples through an application programming interface (API). In a subsequent actual use step, the information collected in real time by the use of the ESS may also be used to continuously update the model in real time.

According to a preferred embodiment of the present disclosure, in the implementation of the algorithm using the reinforcement learning of the present disclosure, the design of a reward function may be applied.

For example, the design of the reward function may be such that the reward function is − for a failed charge and + for a successful charge, and the reward function is updated when the failures accumulate over a certain number of times, and in some cases, the weight is updated. In this case, + means charging fee and − means electricity fee. In this case, the reward function may be designed by subtracting the charging fee in case of failure and updating the weight for the charging fee in case of failure.

According to a preferred embodiment of the present disclosure, upon determining that learning has converged to an appropriate level, the model is validated on real data. For example, charging failure probability is set to 0.5% (setting value) and the electricity price and contracted power are compared with the existing power management method. In this case, if the failure rate does not reach a target value, a method of increasing the contract power and ESS capacity and performing learning again may be used as the reinforcement learning method.

According to a preferred embodiment of the present disclosure, AI technology that essentially uses information collected through various routes to perform learning and elaborate optimization may be applied to the reinforcement learning method.

According to a preferred embodiment of the present disclosure, in order to implement a database regarding collection of ESS usage information, for example, OpenAPI provided by the Korea Environment Corporation in the form of REST API may be utilized as electric vehicle charging station information. The ESS usage information may be databased by updating the state of public and private charging stations nationwide in real time to promote the spread of electric vehicles and provide information for electric vehicle users. Examples of such data may be provided in various forms.

According to the present disclosure, in order to analyze collected API data, it is necessary to retrieve historical data; however, the API can provide only real-time states. Therefore, it is necessary to continuously query the API and store the changing values. Source code implementing this may be received from public or private sources and may be databased.

According to a preferred embodiment of the present disclosure, for example, an electric vehicle charging station information DB may be updated with charging start and end times. Therefore, AI-based application may determine how to set the SoC of the ESS over time to maximize profit.

According to a preferred embodiment of the present disclosure, implementation of the charging and discharging algorithm using such a database may be achieved using an algorithm with an objective function of electric bill minimization. For example, when the overall utility is determined using the entire DB, processing may be performed for each charging station or the model may be updated periodically to maximize efficiency.

In addition, according to a preferred embodiment of the present disclosure, for demand forecast, the hourly (hour, day, month, day of the week, etc.) demand may be predicted based on usage as described above. When the algorithm described above is used together, therefore, it is possible to further increase the accuracy of the ESS SoC control. In this case, for example, a recurrent neural network (RNN), long short-term memory (LSTM), etc. may be used.

In addition, according to a preferred embodiment of the present disclosure, the latitude, longitude, and address of the consumer are provided to acquire location information, which may be used in conjunction with the previous usage data to find a location where a new charging station is required. In this case, for example, technology, such as a geographic information system (GIS), location set covering problem (LSCP), and gradient boosted regression trees (GBRT), may be used.

According to a preferred embodiment of the present disclosure, the database used for the ESS charging and discharging algorithm may be utilized after appropriate adjustment, such as further processing, correction, or error checking, as needed.

According to a preferred embodiment of the present disclosure, an embodiment to which a charge/discharge algorithm for managing the charge/discharge state of an ESS proposed by the present disclosure is applied may include a database unit including one or more pieces of real-time accumulated information, among specifications, usage, and management state of the ESS, a state information collection unit configured to collect and update information related to the state of charge (SoC) of the ESS in real time, a usage state recognition unit including situational information checked during use of the ESS, an algorithm generating unit configured to apply an algorithm including continuous API query and storage of change values to the information from one or more of the database unit, the state information collection unit, and the usage state recognition unit, and an execution command unit configured to determine whether or not to use the ESS including application of a compensation function to the algorithm.

Thus, according to the present disclosure, hourly ESS SoC control may be performed in real time based on data collected from a single ESS or a plurality of ESSs. This effect is preferably realized by the method proposed by the present disclosure.

According to the present disclosure, the power received from the power plant may be minimized in contrast to a conventional approach, and it is possible to efficiently optimizing transmission losses by application of the ESS charging and discharging algorithm with the AI-based continuous API query and fluctuation value storage proposed by the present disclosure.

According to a preferred embodiment of the present disclosure, the charging and discharging algorithm for ESS applicable to the present disclosure, i.e., the collection and update of SoC-related information, may optimize the amount of power used by the power grid in consideration of battery charging and discharging time information, battery charging and discharging efficiency, artificial intelligence, and the like. Here, the step of collecting and updating the SoC-related information may include applying an ESS management algorithm using machine learning-based artificial intelligence including a reinforcement learning technique using one or more reference data sets associated with the power charging station.

According to a preferred embodiment of the present disclosure, the ESS charging and discharging algorithm is further configured to analyze geolocation information and address information of existing power charging stations to optimize a location where a new ESS is to be installed, and the algorithm may use a geographic information system (GIS), location set covering problem (LSCP), and gradient boosted regression trees (GBRT).

According to a preferred embodiment of the present disclosure, when the ESS includes vanadium-based battery cells, typically VIB cells, cell balancing may be performed in consideration of the characteristics of vanadium-based battery cells in which the open-circuit voltage (OCV) decreases as the temperature increases, wherein the OCV increases as the temperature decreases, taking into account at least some aspects related to cell balancing.

According to a preferred embodiment of the present disclosure, in the step of performing balancing of the vanadium-based battery cells, thermal management may be performed on the vanadium-based battery cells for active or passive balancing of the state-of-charge (SoC) values, and the temperature of the vanadium-based battery cells may be increased by at least 5° C. to improve battery efficiency. Here, for example, it may be desirable to perform thermal management on the vanadium-based battery cells such that the vanadium-based battery cells are maintained at an optimal operating efficiency temperature range of 15° C. to 40° C. and the temperature does not exceed 50° C. in any case.

Since the present disclosure is configured to utilize an ESS installed at an optimized location in consideration of power consumption and distance during transmission from a power plant or a substation to a consumer, transmission losses may be minimized by adjusting the unnecessary or excessive transmission state or the transmission state during times of excessive power consumption. Thus, an energy saving system capable of suppressing power waste may be realized.

In addition, since the transmission loss minimization management system of the present disclosure may reduce energy lost during transmission, the system may contribute to efficient energy use and carbon neutrality, and may be used as an environmentally friendly measure, whereby it is necessary to apply the system of the present disclosure in various places in the future.

Also, in the present disclosure, the transmission loss minimization costs may be converted and charged to the supplied for compensation, whereby it is possible to improve the service of consumers for energy supply and to rationalize the power bill. Therefore, when the VIB cells are applied to the ESS, it possible to supply power to consumers everywhere in safe, stable, and highly economical conditions without any fire concerns.

While preferred embodiments of the present disclosure have been described above with reference to the accompanying drawings, it should be understood that the embodiments described in this specification and constructions shown in the drawings are merely the most preferred embodiments and do not speak for the entirety of the technical idea of the present disclosure, and therefore various replaceable equivalents and modifications may be possible at the time of filing the present application. Therefore, the description and examples set forth above are to be understood as exemplary as one embodiment and not limiting in all respects, and the scope of the present disclosure is indicated by the following claims rather than by the detailed description, and all modifications or variations derived from the meaning and scope of the claims and the equivalent concepts thereof are to be construed as being within the scope of the present disclosure.

1. A transmission loss minimization management system wherein an energy storage system (ESS) for storing power is installed between a power plant and a substation or between a power plant or a substation and a consumer as an auxiliary means of power supply, in a transmission process from the power plant to the substation or from the substation to another substation or the consumer, a supply of power from the ESS is supplemented according to a power demand forecast result or a distance to the consumer, and the system comprises one or more of assisting the transmission from the ESS when the power demand is equal to or greater than a standard value and assisting some of the power stored in the ESS in the vicinity of the substation or the consumer.

2. The transmission loss minimization management system of claim 1, wherein the system comprises one or more of supplementing daytime output in consideration of characteristics of high daytime demand for power and reduced nighttime demand for power and supplementing some of the power at the ESS installed in the vicinity of the substation or the consumer.

3. The transmission loss minimization management system of claim 1, wherein the system comprises recording a demand curve for power, supplementing the power supply from the ESS by excess demand power when the power demand exceeds a certain level, receiving power from the power plant or the substation and charging the ESS if the power demand is equal to or less than the certain level, estimating a loss minimization cost of the transmission power calculated by dividing a power consumption time period of the consumer into certain sections and calculating a transmission loss minimization cost by Mathematical Equation 1 below, and receiving compensation by charging all or some of a value corresponding to a difference generated by the loss minimization cost to a power supplier.
$$Transmission minimization cost = {\sum }_{time} \{ ( estimated amount of transmission losses based on existing demand ) - ( actual amount of transission losses ) \} \times ( power cost by time of day ) \qquad [ Mathematical Equation 1 ]$$

4. The transmission loss minimization management system of claim 1, wherein an optimal location of the ESS is selected in consideration of a location of the power plant, a location of the substation, or a location of the consumer based on a distance and distribution between the locations, and a location where power loss costs can be minimized to a maximum extent is selected based on an estimate result of the transmission loss costs by simulation such that the ESS is installed at the location.

5. The transmission loss minimization management system of claim 1, wherein the ESS comprises:
a database unit comprising one or more pieces of real-time accumulated information, among specifications, use, and management state of the ESS for at least one ESS;
a state information collection unit configured to collect and update information related to a state of charge (SoC) of the ESS in real time;
a usage state recognition unit comprising situational information checked during use of the ESS;
an algorithm generating unit comprising continuous API query and storage of change values to the information from one or more of the database unit, the state information collection unit, and the usage state recognition unit; and
a central controller having a charging and discharging algorithm comprising an execution command unit configured to determine whether or not to use the ESS applied thereto.

6. The transmission loss minimization management system of claim 1, wherein the ESS comprises information in which a start time and an end time of battery charging are undated.

7. The transmission loss minimization management system of claim 1, wherein the charging and discharging algorithm comprises an objective function of electric bill minimization.

8. The transmission loss minimization management system of claim 1, wherein the ESS comprises demand forecast data.

9. The transmission loss minimization management system of claim 1, wherein the ESS utilizes information for acquiring location information for newly created or decommissioned power plants, substations, and consumers.

10. The transmission loss minimization management system of claim 1, wherein at least a part of the ESS comprises vanadium-based battery cells.

11. An ESS installation system for transmission loss minimization wherein
an energy storage system (ESS) for storing power is installed between a power plant and a substation or between a power plant or a substation and a consumer as an auxiliary means of power supply, and
the ESS comprises:
a database unit comprising one or more pieces of real-time accumulated information, among specifications, use, and management state of the ESS for at least one ESS;
a state information collection unit configured to collect and update information related to a state of charge (SoC) of the ESS in real time;
a usage state recognition unit comprising situational information checked during use of the ESS; and
a central controller comprising a means configured to regulate charging and discharging of the ESS when a transmission power capacity of the power plant and the substation and a power demand of the consumer are equal to or greater than a standard value.

12. The ESS installation system of claim 11, wherein the ESS is installed at a predetermined location according to a power demand forecast result or a distance to the consumer in a transmission process from the power plant to the substation or from the substation to another substation or the consumer.

13. The ESS installation system of claim 11, wherein the ESS supplies power according to a power demand forecast result or a distance to the consumer in a transmission process from the power plant to the substation or from the substation to another substation or the consumer.

14. A transmission relay cost charging method through transmission loss minimization management, the transmission relay cost charging method comprising: recording a demand curve of power transmitted from a power plant or a substation to a consumer; a transmission assistance step of transmitting pre-stored power from at least one energy storage system (ESS) installed between the power plant and the substation or between the power plant or the substation and the consumer as an auxiliary means of power supply when a power demand exceeds a certain level; charging the ESS when the power demand is equal to or less than the certain level; estimating a loss minimization cost of the transmission power calculated by dividing a daily time period into certain sections and calculating a transmission minimization cost by Mathematical Equation 1 below; and receiving compensation by charging all or some of a value equivalent to the amount to a supplier.
$$Transmission minimization cost = {\sum }_{time} \{ ( estimated amount of transmission losses based on existing demand ) - ( actual amount of transission losses ) \} \times ( power cost by time of day ) \qquad [ Mathematical Equation 1 ]$$

15. The transmission relay cost charging method of claim 14, wherein one or more ESSs are installed according to a location of the power plant, a location of the substation, and a distribution of consumers, and the cost is charged according to transmission loss minimization in each section.

16. A transmission loss minimization management system comprising: supplementing daytime output in consideration of characteristics of high daytime demand for power and reduced nighttime demand for power; and supplementing some of the power, wherein supplementary supply is performed utilizing an ESS installed in the vicinity of a power plant, a substation, or a consumer, to which power is supplied, the ESS comprising a vanadium-based battery cell.

17. A transmission loss minimization management system comprising: recording a demand curve of power; supplementing a supply of power using an energy storage system (ESS) comprising a vanadium-based battery cell when a demand exceeds a certain level; charging the ESS when the demand is equal to or less than the certain level; estimating a loss minimization cost of transmission power calculated by dividing a daily time period into certain sections and calculating a transmission minimization cost according to Mathematical Equation 1 below; and receiving compensation by charging all or some of the amount to a supplier
$$Transmission minimization cost = {\sum }_{time} \{ ( estimated amount of transmission losses based on existing demand ) - ( actual amount of transission losses ) \} \times ( power cost by time of day ) \qquad [ Mathematical Equation 1 ]$$
